(19) United States
(12) Patent Application Publication
(10) Pub. No.: US 2004/0019470 A1
(43) Pub. Date: Jan. 29, 2004

(54) Control of complex manufacturing processes using continuous process data

(75) Inventors: Jill P. Card, West Newbury, MA (US); Wai T. Chan, Newburyport, MA (US); An Cao, Arlington, MA (US)

Correspondence Address: TESTA, HURWITZ & THIBEAULT, LLP, HIGH STREET TOWER, 125 HIGH STREET, BOSTON, MA, 02110, US

(73) Assignee: Ibex Process Technology, Inc., Lowell, MA

(21) Appl. No.: 10/621,532

(22) Filed: Jul. 17, 2003

Related U.S. Application Data
(60) Provisional application No. 60/397,282, filed on Jul. 19, 2002.

(51) Int. Cl. G06F 17/10

(52) U.S. Cl. 703/2

(57) ABSTRACT

Complex process prediction and optimization are performed utilizing an orthogonal transform to represent time-varying continuous signals as discrete values, which are then subjected to a nonlinear regression analysis to relate between the discrete values and process metrics.

### CROSS REFERENCE TO RELATED APPLICATIONS

The present application claims the benefit of and priority to U.S. provisional application Serial No. 60/397,282, filed Jul. 19, 2002, the entire disclosure of which is herein incorporated by reference.

### FIELD OF THE INVENTION

The invention relates to the field of process control. In particular, the invention relates prediction and/or control of complex multi-step processes.

### BACKGROUND

Process prediction and control is crucial to optimizing the outcome of complex multi-step production processes. For example, the production process for integrated circuits comprises hundreds of process steps (i.e., sub-processes). Each process step, in turn, may have several controllable parameters, or inputs, that affect the outcome of the process step, subsequent process steps, and/or the process as a whole. In addition, the impact of the controllable parameters on outcome may vary from process run to process run, day to day, or hour to hour. The typical integrated circuit fabrication process thus has a thousand or more controllable inputs, any number of which may be cross-correlated and have a time varying, nonlinear relationship with the process outcome. As a result, process prediction and control is crucial to optimizing process parameters and to obtaining, or maintaining, acceptable outcomes.

Regression techniques have been used to model relationships between various process and sub-process variables and characteristics of the process output (e.g., the quality, according to at least one metric of interest, of a finished product). The use of neural networks has facilitated successful modeling of processes having large numbers of variables whose interrelationship and contribution to the output metric of interest cannot easily be described.

Yet today, complex manufacturing systems frequently utilize sensors that monitor processes and sub-processes on a continuous basis. The result is, in effect, an infinite number of discrete values generated over time. Although these data consume precious hardware resources, they do not readily lend themselves to regression analysis.

Lada et al. subject time-varying process data to wavelet analysis in order to detect process faults. See Lada et al., “A Wavelet-Based Procedure for Process Fault Detection, IEEE Transactions on Semiconductor Manufacturing 15(1):79-90 (2002) (hereafter “Lada et al.”). Wavelet transforms, like a Fourier transform, decompose a complex time-varying signal into simpler building blocks. Unlike a Fourier transform, however, wavelet analysis includes locality in both time and frequency domains.

More specifically, a Fourier transform portrays a time-varying signal as a superposition of simple sinusoids with different frequencies, the Fourier coefficients measuring the contributions of these different frequencies to the original signal. Accordingly, the original signal can be fully reconstructed from sinusoidal signals by summing them in accordance with the amplitudes specified by the Fourier coefficients. The sinusoids specified by Fourier analysis are not time-bound; in effect, they oscillate forever. Wavelet analysis also decomposes a time-varying signal into simpler elements, i.e., wavelets, but a wavelet—unlike a Fourier sinusoid—is localized in time, typically lasting only a few cycles. Wavelet transforms represent a source signal as a sum of wavelets with different locations (in the time domain) and scales. The wavelet coefficients essentially quantify the contributions of the wavelets at these locations and scales. By using small, time-bound signals as building blocks, wavelet analysis can represent certain types of source signals (particularly those dominated by transient behavior or discontinuities) more efficiently.

Lada et al. utilize wavelet analysis to transform mass-spectral data signals and thereby compute likely process failures in a thermal chemical vapor deposition (CVD) process. A small number of selected wavelet coefficients serve as a manageable data set for failure analysis. Process faults are detected based on differences between (i) the wavelet coefficients estimated from several independent runs of the in-control process, and (ii) the corresponding wavelet coefficients estimated from a single run of a process to be tested for an out-of-control condition. Accordingly, the applicability of this approach is limited to post hoc fault detection, and depends on the ability to distinguish between fully acceptable and unacceptable process runs. It does not lend itself to prediction or process optimization.

### SUMMARY OF THE INVENTION

The present invention provides a method and system for complex process prediction and optimization by utilizing an orthogonal transform to represent time-varying continuous signals as discrete values (transform coefficients), which are then subjected to a nonlinear regression analysis capable of handling the potentially large number of coefficients and their complex relationship.

In one aspect, the invention comprises a method of prediction of a process having an associated process metric by obtaining time-varying measurements of parameters relating to the process; decomposing the time-varying measurements into discrete measurement values using an orthogonal transform; and modeling a relationship between the discrete measurement values and the associated process metric to determine a predicted process metric value from an input set of discrete measurement values. In one embodiment, the modeling step comprises building a nonlinear regression model of the relationship between the discrete measurement values and the associated process metric to predict a process metric value. In some embodiments, the orthogonal transform may be a Fourier transform. In other embodiments, the orthogonal transform may be a wavelet transform.

In one embodiment of the invention, at least one range of acceptable values for the discrete measurement values is used to define a constraint set, a plurality of input process variables are identified that produce discrete measurement values within the constraint set, and the modeled relationship in conjunction with an optimizer determine the discrete measurement values, produced by the input process variables, that produce a predicted process metric value substantially as close as possible to a target process metric value.

The method may be repeated for at least one sub-process of a process, where at least the one sub-process of the process becomes the “process” in the steps outlined above. The method may be alternatively or in addition repeated for a higher level process comprising a plurality of processes, where the higher level process becomes the “process” and at least one of the processes become “sub-processes” for purposes of analysis.

In general, the input set of discrete measurement values is obtained by decomposing time-varying measurements into discrete measurement values using an orthogonal transform.

In another aspect, the invention comprises a method of prediction and optimization of maintenance actions for a process by obtaining time-varying measurements of parameters relating to the process; decomposing the time-varying measurements into discrete measurement values using an orthogonal transform; and modeling a relationship between at least one maintenance variable and the discrete measurement values to determine predicted measurement values from an input set of maintenance variable records (e.g., elapsed time between tool calibration, tool repair frequency, and so on). In one embodiment, the modeling step comprises building a nonlinear regression model of the relationship between at least one maintenance variable and the discrete measurement values to determine the predicted measurement values. In some embodiments, the nonlinear regression model maps a relationship between (i) a plurality of maintenance variables and process inputs and (ii) the discrete measurement values, and determines a predicted measurement value from an input set of maintenance-variable values. In some embodiments, the orthogonal transform may be a Fourier transform. In other embodiments, the orthogonal transform may be a wavelet transform.

In some embodiments, the method further comprises providing at least one range of acceptable values for at least one maintenance variable to define a constraint set, and using the modeled relationship in conjunction with an optimizer to determine values for the at least one maintenance variable within the constraint set that produce at least one predicted discrete measurement value substantially as close as possible to a target discrete measurement value. In some embodiments, costs are associated with at least one of the maintenance values. The nonlinear regression model may map a relationship between an input set comprising at least one maintenance variable and the discrete measurement values, and the process inputs in order to determine a predicted process metric value from an instance of the input set.

In another aspect, the invention comprises an article of manufacture having a computer-readable medium with the computer-readable instructions embodied thereon for performing the methods described in the preceding paragraphs. In particular, the functionality of a method of the present invention may be embedded on a computer-readable medium, such as, but not limited to, a floppy disk, a hard disk, an optical disk, a magnetic tape, a PROM, an EPROM, CD-ROM, or DVD-ROM. The functionality of the method may be embedded on the computer-readable medium in any number of computer-readable instructions, or languages such as, for example, FORTRAN, PASCAL, C, C++, Tcl, BASIC and assembly language. Further, the computer-readable instructions can, for example, be written in a script, macro, or functionally embedded in commercially available software (such as, e.g., EXCEL or VISUAL BASIC).

In other aspects, the present invention provides a system for predicting a process having an associated metric. In one embodiment, the system comprises a process monitor and a data processing device. The process monitor monitors time-varying measurements relating to process parameters or process metrics of the process. The data processing device decomposes the time-varying measurements into discrete measurement values using an orthogonal transform and builds a nonlinear regression model of a relationship between the discrete measurement values and the associated process metric to determine a predicted process metric from an input set of discrete measurement values.

In some embodiments, the system comprises a process controller, responsive to the data processing device, for adjusting at least one of the processes based on the predicted process metric. The system may comprise a data storage device for providing at least one range of acceptable values for the discrete measurement values. In other embodiments, the system comprises an optimizer for determining values for the process inputs that produce a predicted discrete measurement values substantially as close as possible to a target values provided by the storage device. In some embodiments, the optimizer is a feature of the data processing device.

In another aspect, the present invention provides a system for predicting and optimizing maintenance actions for a process. In one embodiment, the system comprises a process monitor and a data processing device. The process monitor monitors time-varying measurements relating to process parameters or process metrics of the process. The data processing device decomposes the time-varying measurements into discrete measurement values using an orthogonal transform and builds a nonlinear regression model of a relationship between at least one maintenance variable and the discrete measurement values to determine the predicted discrete measurement values from an input set of maintenance values.

In some embodiments, the system comprises a process controller, responsive to the data processing device, for adjusting at least one of the processes based on the predicted process metric. In some embodiments, the system comprises a data storage device for providing at least one range of acceptable values for the discrete measurement values. The system may comprise an optimizer for determining measurement values that produce a predicted process metric value substantially as close as possible to a target process metric and are within the at least one range of acceptable values for the discrete measurement values provided by the storage device. In some embodiments, the optimizer is a feature of the data processing device.

The foregoing and other objects, aspects, features, and advantages of the invention will become more apparent from the following description and from the claims.

### BRIEF DESCRIPTION OF THE DRAWINGS

A fuller understanding of the advantages, nature and objects of the invention may be had by reference to the following illustrative description, when taken in conjunction with the accompanying drawings. The drawings are not necessarily drawn to scale, and like reference numerals refer to the same items throughout the different views.

FIG. 1 is a flow diagram illustrating various embodiments of prediction and optimization of a process according to the present invention.

FIG. 2 is a more detailed diagram illustrating a transform function of other various embodiments of prediction and optimization relating to the invention.

FIG. 3 is a flow diagram illustrating another embodiment of prediction and optimization of a process according to the present invention.

FIG. 4 is a flow diagram illustrating another embodiment of prediction and optimization of a process according to the present invention.

FIG. 5 is a flow diagram illustrating another embodiment of prediction and optimization of a process according to the present invention.

FIG. 6 is a flow diagram illustrating another embodiment of prediction and optimization of a process according to the present invention.

FIG. 7 is a schematic illustration of various embodiments of a system adapted to practice the methods of the present invention.

### DETAILED DESCRIPTION

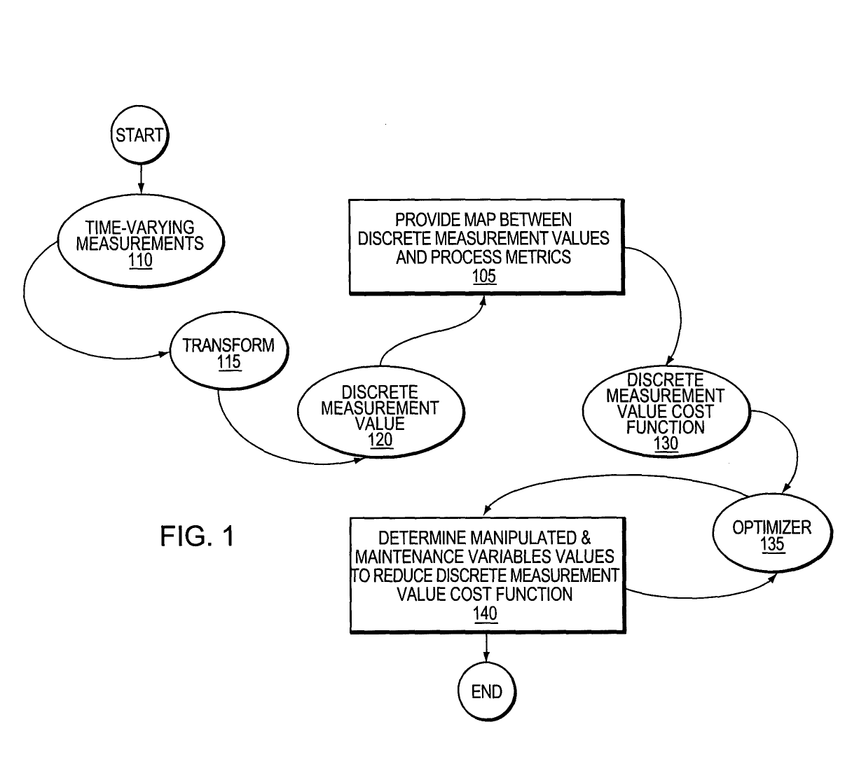

FIG. 1 illustrates an overview of various embodiments of a method of process optimization according to the present invention. The method begins by providing a map between discrete measurement values of a process and the process metrics 105 that are used to measure the process. As used herein, the term “metric” refers to any parameter used to measure the outcome or quality of a process or sub-process (e.g., the yield, a quantitative indication of output quality, etc.). Metrics include parameters determined both in situ during the running of a sub-process or process, and ex situ, at the end of a sub-process or process. In one embodiment, the measurements comprise at least one time-varying measurement 110. An orthogonal transform 115 decomposes the time-varying measurement(s) 110 into discrete measurement values 120. Further provided is an acceptable range of discrete measurement values 120, and a cost function 130 for the discrete measurement values 120. Preferably, the map 105 is realized in the form of a nonlinear regression model trained in the relationship between the discrete measurement values and process metrics such that the model can determine one or more predicted process metric values from one or more discrete measurement values. The process is preferably optimized using the map 105 and an optimization model 135 to determine discrete measurement values 140 that are within the acceptable range of discrete measurement values 120, and that produce at the lowest cost a process metric(s) that is as close as possible to a target process metric(s).

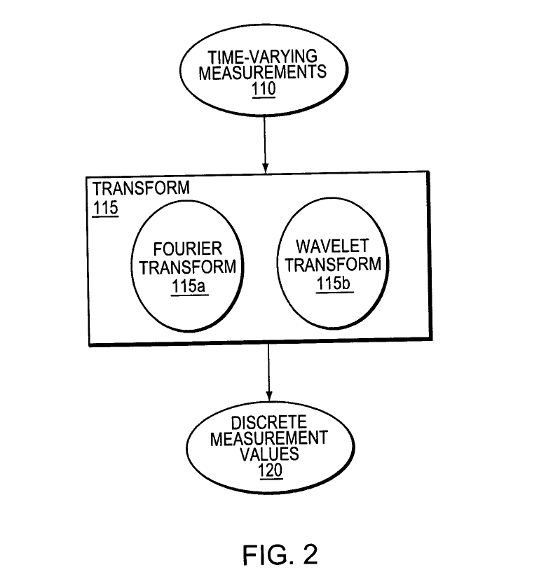

Referring to FIG. 2, the method of decomposing the continuous time-varying measurements into discrete measurement values process optimization comprises applying an orthogonal transform 115. In some embodiments, the orthogonal transform 115 is a Fourier transform 115a. In other embodiments, the orthogonal transform 115 is a wavelet transform 115b.

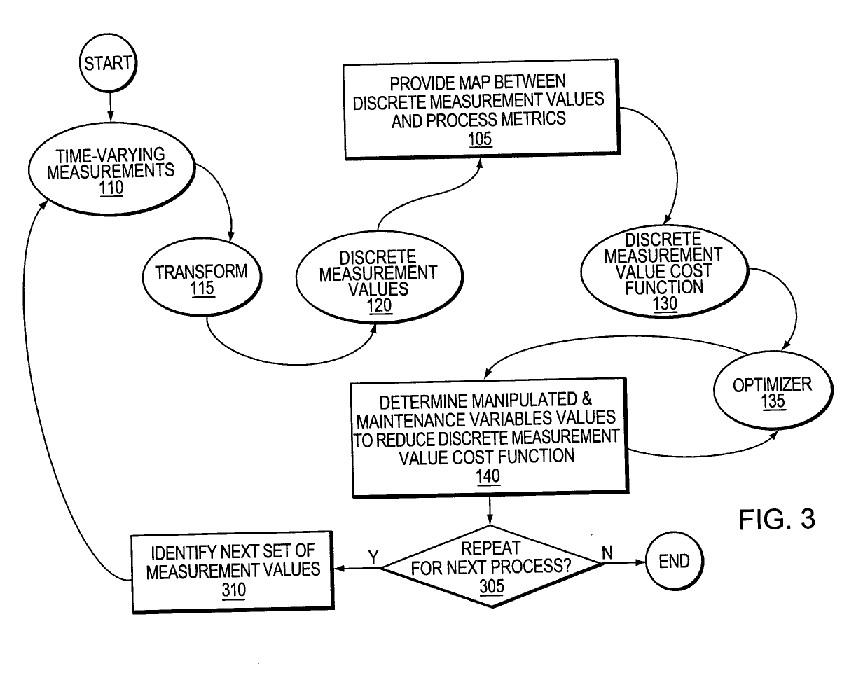

Referring to FIG. 3, the optimized process may have a hierarchical organization, with some portions or steps representing sub-processes of other portions or steps of the process. In such cases, the process optimization method outlined above further comprise repeating the above optimization method for the individual process components at different hierarchical process levels (“YES” to query 305). For example, the procedure may be repetitively applied (step 310) to each sub-process, each sub-process having its own set of measurement values, and then to the overall process, which may itself represent a sub-process of a higher-order process to which the optimization procedure is applied. See, e.g., co-pending published patent application serial No. 10/243,963, filed on Sep. 13, 2002, the entire disclosure of which is herein incorporated by reference.

In all of the embodiments of the present invention, the map between the process metric(s) and the discrete measurement values can be provided, for example, through the training of a nonlinear regression model against observed time-varying measurements transformed into discrete measurement values. The discrete measurement values from each process run serve as the input to a nonlinear regression model, such as a neural network. The output of the nonlinear regression model is a predicted process metric(s). The nonlinear regression model is preferably trained by comparing process metric(s) calculated by the model, based on discrete measurement values for an actual process run with the actual process metric(s) as measured for that process run. The difference between the computed (i.e., predicted) process metric(s) and the measured process metric(s), or the error, is used to correct adjustable parameters in the regression model. In a preferred embodiment, the regression model is a neural network in which the adjustable parameters are the connection weights between the layers of the neurons in the network.

In one version, the neural network model architecture comprises a multi-layer feed-forward model with cascade architecture beginning with no hidden units and an adaptive gradient algorithm for back-propagation of prediction errors to adjust network weights. During training, hidden units are trained to maximize the correlation between the hidden unit's outputs and the residual error at the output of the current training process metrics (i.e. training vector). The new hidden units are added one at a time (or in vector candidate groups) and “cascaded” through weights to subsequent units to reduce the residual error not explained by previous hidden nodes.

As used herein, the term “manipulated variables” refers to input variables associated with the manipulated parameters of a process, i.e., parameters that may be set or adjusted by supervising personnel. Manipulated variables include, for example, process step controls such as, for example, set point adjustments. As used herein, the term “maintenance variables” refers to input variables associated with the maintenance parameters of a process. For example, maintenance variables may indicate the wear, repair, or replacement status of a sub-process component(s) (referred to herein as “replacement variables”), and variables that indicate the calibration status of the process controls (referred to herein as “calibration variables”).

For example, where the process comprises plasma etching of silicon wafers, the manipulated variables for a plasma etch sub-process, such as performed by a LAM 4520 plasma etch tool, may include, e.g., RF power and process gas flow. Replacement variables may include, e.g., time since last electrode replacement and/or a binary variable that indicates the need to replace/not replace the electrodes. Calibration variables may include, e.g., time since last machine calibration and/or the need for calibration.

A deviating process is one that exhibits a process metric outside an acceptable range of values about a target value for the process metric. The deviation may arise, for example, from a malfunction in the process, an intentional change in the process, and/or the inability of a process, or process operator, to produce a process metric within the acceptable range of values about a target value for the process metric. The invention minimizes losses caused by a deviation by predicting the deviation in a timely fashion.

As described more fully below, in one embodiment of the invention, process signals are subjected to an orthogonal transform to produce a matrix of transform coefficients. These coefficients are then mapped, via a neural network, to post-process metrics. In another embodiment, the matrix of coefficients along with a record of maintenance actions are fed into a neural network for mapping to the same set of post-process metrics. In a third embodiment, a neural network is trained on the inverse mapping of maintenance actions to the matrix of coefficients. These coefficients are then used as arguments to an optimization to compute an ideal maintenance action vector. In a fourth embodiment, the matrix of coefficients, a vector of maintenance actions, and/or a vector of in situ process signals are processed by a neural network to predict post-process product/process metrics.

1. Mathematical Techniques

Orthogonal transforms useful in accordance with the present invention are detailed in Rietman et al., “A Study on R^{lll} →R¹Maps: Application to a 0.16 micron Via Etch Process Endpoint,” IEEE Transactions on Semiconductor Manufacturing 13(4):457-468 (2000) (hereafter “Rietman et al.”), and incorporated by reference herein.

The discrete Fourier transform X of a vector x of length N is given by:

$$\begin{matrix}{X}_{f} = \frac{1}{\sqrt{N}} {\sum }_{n = 0}^{N - 1} {ⅇ}^{\frac{2 π ⅈ {f}_{n}}{N}} {x}_{n} \\ ≡ {\sum }_{n = 0}^{N - 1} {M}_{{f}_{n}} {x}_{n}\end{matrix} \qquad Eq . ( 1 )$$

where X_{f} are the Fourier coefficients and f is frequency. Knowing X_{f} is sufficient to reconstruct the original signal x through an inverse Fourier transform.

Wavelet transforms also produce a similar list of coefficients that can be used to recover the original signal. A representative wavelet transform is given by:

$${g}_{k} = \sqrt{2} {\int }_{- ∞}^{∞} ψ ( t ) ϕ ( 2 t - k ) ⅆ t \qquad Eq . ( 2 )$$

where gₖ are the coefficients generated from the transform, ψ(t) is the wavelet kernel function, φ(2t−k) is a transformation of the original signal φ(t) by dilation and translation, and t is the time scale. See, e.g., He, J., Mathematica Wavelet Explorer (1996).

Other orthogonal transforms useful in connection with the present invention include other Fourier-like expansions, such as Andrews plots (see Andrews, “Plots of high-dimensional data,” Biometrics 23:125-136 (1972), incorporated by reference herein) and other Fourier series, Legendre polynomials, Chebyshev polynomials, and singular value decomposition.

In a preferred embodiment, the nonlinear regression model utilized herein comprises a neural network. Specifically, in one version, a three-layer neural network model and training is as follows. The output of the neural network, vector r, is given by

$${r}_{k} = {\sum }_{j} [ {W}_{j k} \cdot tanh ( {\sum }_{j} {W}_{i j} \cdot {x}_{i} ) ] . \qquad Eq . ( 3 )$$

This equation states that the i^{th} element of the input vector x is multiplied by the connection weights Wᵢⱼ. This product is then the argument for a hyperbolic tangent function, which results in another vector. This resulting vector is multiplied by another set of connection weights Wⱼₖ. The subscript i spans the input space (i.e., sub-process metrics). The subscript j spans the space of hidden nodes, and the subscript k spans the output space (i.e., process metrics). The connection weights are elements of matrix W, and are chosen to minimize the mathematical cost, for example, by gradient search of the error space. The cost function for the minimization of the output response error is given by

$$C = {[ {\sum }_{j} {( t - r )}^{2} ]}^{1 / 2} + γ {‖ W ‖}^{2} \qquad Eq . ( 4 )$$

The first term represents the root-mean-square (“RMS”) error between the target t and the output r. The second term is a constraint that minimizes the magnitude of the connection weight W. If γ (called the regularization coefficient) is large, it will force the weights to take on small magnitude values. The coefficient γ thus acts as an adjustable parameter for the desired degree of non-linearity in the model. Minimizing the cost function will tend to minimize the error and force this error to the best optimal among all the training examples.

In all of the embodiments of the present invention, the cost function can be representative, for example, of the actual monetary cost, or the time and labor, associated with achieving a sub-process metric. The cost function may also be representative of an intangible such as, for example, customer satisfaction, market perceptions, or business risk. Accordingly, it should be understood that it is not central to the present invention what, in actuality, the cost function represents; rather, the numerical values associated with the cost function may represent anything meaningful in terms of the application. Thus, it should be understood that the “cost” associated with the cost function is not limited to monetary costs.

The condition of lowest cost, as defined by the cost function, is the optimal condition, while the requirement of a metric or operational variable to follow defined cost functions and to be within accepted value ranges represents the constraint set. Cost functions are preferably defined for all input and output variables over the operating limits of the variables. The cost function applied to the vector z of n input and output variables at the nominal (current) values is represented as f(z) for zεRⁿ.

For input and output variables with continuous values, a normalized cost value is assigned to each limit and an increasing piecewise linear cost function assumed for continuous variable operating values between limits. For variables with discrete or binary values, the cost functions are expressed as step functions.

In one embodiment, the optimization model (or method) comprises a genetic algorithm. In another embodiment, the optimization is as for Optimizer I described below. In another embodiment, the optimization is as for Optimizer II described below. In another embodiment, the optimization strategies of Optimization I are utilized with the vector selection and pre-processing strategies of Optimization II.

Optimizer I

In one embodiment, the optimization model is stated as follows:

Min f(z)

zεRⁿ

s.t. h(z)=a

z^{L}<z<z^{U}

where f: Rⁿ→R and h: Rⁿ→Rⁿ.

Vector z represents a vector of all input and output variable values, f(z), the objective function, and h(z), the associated constraint vector for elements of z. The variable vector z is composed of sub-process metric inputs, and process metric outputs. The vectors z^{L} and z^{U} represent the lower and upper operating ranges for the variables of z.

In one implementation, the optimization method focuses on minimizing the cost of operation over the ranges of all input and output variables. The procedure seeks to minimize the maximum of the operating costs across all input and output variables, while maintaining all within acceptable operating ranges. The introduction of variables with discrete or binary values requires modification to handle the yes/no possibilities for each of these variables.

The following basic notation is useful in describing this optimization model.

m₁=the number of continuous input variables.

m₂=the number of binary and discrete input variables.

p=the number of output variables.

m=m₁+m₂, the total number of input variables.

z^{m}^{₁}εR^{m}^{₁}=vector of m₁ continuous input variables.

z^{m}^{₂}εR^{m}^{₂}=the vector of m₂ binary and discrete input variables.

z^{p}εR^{p}=the vector of p continuous output variables.

Also let

zεRⁿ=[z^{m}^{₁}, z^{m}^{₂}, z^{p}], the vector of all input variables and output variables for a given process run.

As mentioned above, two different forms of the cost function exist: one for continuous variables and another for the discrete and binary variables. In one embodiment, the binary/discrete variable cost function is altered slightly from a step function to a close approximation that maintains a small nonzero slope at no more than one point.

The optimization model estimates the relationship between the set of continuous input values and the binary/discrete variables [z^{m}^{₁}, z^{m}^{₂}] to the output continuous values [z^{p}]. In one embodiment, adjustment is made for model imprecision by introducing a constant error-correction factor applied to any estimate produced by the model specific to the current input vector. The error-corrected model becomes,

g′(z^{m}^{₁}, z^{m}^{₂})=g(z^{m}^{₁}, z^{m}^{₂})+e₀

where

e₀=m₀−g(z₀^{m}^{₁}, z₀^{m}^{₂});

g(z^{m}^{₁}, z^{m}^{₂})=the prediction model output based on continuous input variables;

g: R^{m}^{₁}^{+m}^{₂}→R^{p} binary and discrete input variables;

g(z₀^{m}^{₁}, z₀^{m}^{₂})=the prediction model output vector based on current input variables;

m₀εR^{p}=the observed output vector for the current (nominal) state of inputs;

c(z)=the cost function vector of all input and output variables of a given process run record; and

c(z(i))=the i^{th} element of the cost function vector, for i=1, . . . , m+p.

For the continuous input and output variables, cost value is determined by the piecewise continuous function. For the p continuous output variables [c(z(m+1)), c(z(m+2)), . . . , c(z(m+p))]=the cost of the p predicted outputs g(z^{m}^{₁}, z^{m}^{₂}).

For c(z), the cost function vector for all the input and output variables of a given process run record, the scalar max c(z)=max{c(z(i)): i=1, 2, . . . , m+p}, is defined as the maximum cost value of the set of continuous input variables, binary/discrete input variables, and output variables.

The optimization problem, in this example, is to find a set of continuous input and binary/discrete input variables which minimize max(c(z)). The binary/discrete variables represent discrete metrics (e.g., quality states such as poor/good), whereas the adjustment of the continuous variables produces a continuous metric space. In addition, the interaction between the costs for binary/discrete variables, c( z^{m}^{₂}), and the costs for the continuous output variables, c( z^{p}), are correlated and highly nonlinear. In one embodiment, these problems are addressed by performing the optimization in two parts: a discrete component and continuous component. The set of all possible sequences of binary/discrete metric values is enumerated, including the null set. For computational efficiency, a subset of this set may be extracted. For each possible combination of binary/discrete values, a continuous optimization is performed using a general-purpose nonlinear optimizer, such as dynamic hill climbing or feasible sequential quadratic programming, to find the value of the input variable vector, zₒₚₜ^{m}, that minimizes the summed total cost of all input and output variables

f(z)=max c(zₒₚₜ(i)) Eq. (5).

Optimizer II

In another embodiment, a heuristic optimization method designed to complement the embodiments described under Optimizer I is employed. The principal difference between the two techniques is in the weighting of the input-output variable listing. Optimizer II favors adjusting the variables that have the greatest individual impacts on the achievement of target output vector values, e.g., the target process metrics. Generally, Optimizer II achieves the specification ranges with a minimal number of input variables adjusted from the nominal. This is referred to as the “least labor alternative.” It is envisioned that when the optimization output of Optimizer II calls for adjustment of a subset of the variables adjusted using the embodiments of Optimizer I, these variables represent the principal subset involved with the achievement of the target process metric. The additional variable adjustments in the Optimization I algorithm may be minimizing overall cost through movement of the input variable into a lower cost region of operation.

In one embodiment, Optimization II proceeds as follows:

Min f (z)

zεΦ

s.t. h(z)=a

z^{L}≦z≦z^{U}

where Φ={z^{j}εRⁿ: j≦sε I; an s vector set}.

f: Rⁿ→R and h: Rⁿ→Rⁿ.

The index j refers to the j^{th} vector of a total of s vectors of dimension n =m +p, the total number of input plus output variables, respectively, which is included in the set to be optimized by f. The determination of s discrete vectors from an original vector set containing both continuous and binary/discrete variables may be arrived at by initial creation of a discrete rate change from nominal partitioning. For each continuous variable, several different rate changes from the nominal value are formed. For the binary variables only two partitions are possible. For example, a continuous variable rate-change partition of −0.8 specifies reduction of the input variable by 80% from the current nominal value. The number of valid rate partitions for the m continuous variables is denoted as nₘ.

A vector z is included in Φ according to the following criterion. (The case is presented for continuous input variables, with the understanding that the procedure follows for the binary/discrete variables with the only difference that two partitions are possible for each binary variable, not nₘ.) Each continuous variable is individually changed from its nominal setting across all rate partition values while the remaining m−1 input variables are held at nominal value. The p output variables are computed from the inputs, forming z.

Inclusion of z within the set of vectors to be cost-optimized is determined by the degree to which the output variables approach targeted values. The notation zᵢₖ (l) ε R, l=1, 2, . . . p, refers to the l^{th} output value obtained when the input variable vector is evaluated at nominal variable values with the exception of the i^{th} input variable which is evaluated at its k^{th} rate partition. In addition, zᵢₖ εR is the value of the i^{th} input variable at its k^{th} rate partition from nominal. The target value for the l^{th} output variable l=1, 2, . . . p is target (l) and the l^{th} output variable value for the nominal input vector values is denoted z₀(l).

The condition for accepting the specific variable at a specified rate change from nominal for inclusion in the optimization stage is as follows.

For each i≦m, and each k≦nₘ

if |(zᵢₖ (l)−target(l))/(z₀(l)−target(l))|<K(l)

for l≦p, 0≦K(l)≦1, and z^{L}≦zᵢ^{j}≦z^{U}

then Zᵢₖ εΔᵢ=acceptable rate partitioned values of the i^{th} input variable.

To each set Δᵢ, i=1, . . . , m is added the i^{th} nominal value. The final set Φ of n-dimension vectors is composed of the crossing of all the elements of the sets Δᵢ of acceptable input variable rate-partitioned values from nominal. Thus, the total number of vectors zεΦ equals the product of the dimensions of the Δᵢ:

$$Total vectors ∈ Φ = ( {\prod }_{i}^{{m}_{1}} {n}_{i} ) * ( {2}^{{m}_{2}} ) \qquad Eq . ( 6 )$$

for m₁=the number of continuous input variables

m₂=the number of binary and discrete variables.

The vector set Φ resembles a fully crossed main effects model which most aggressively approaches one or more of the targeted output values without violating the operating limits of the remaining output values.

This weighting strategy for choice of input vector construction generally favors minimal variable adjustments to reach output targets. In one embodiment, the Optimization II strategy seeks to minimize the weighted objective function

$$f ( {z}^{j} ) = {\sum }_{i = 1}^{m} c ( {z}_{i}^{j} ) + p {V ( {\prod }_{i = m + 1}^{m + p} c ( {z}_{i}^{j} ) )}^{1 / p} \qquad Eq . ( 7 )$$

for pV. The last p terms of z are the output variable values computed from the n inputs. The term

$${( {\prod }_{i = m + 1}^{m + p} c ( {z}_{i}^{j} ) )}^{1 / p}$$

is intended to help remove sensitivity to large-valued outliers. In this way, the approach favors the cost structure for which the majority of the output variables lie close to target, as compared to all variables being the same mean cost differential from target.

Values of pV>>3 represent weighting the adherence of the output variables to target values as more important than adjustments of input variables to lower cost structures that result in no improvement in quality.

In another embodiment, the Optimization II method seeks to minimize the weighted objective function

$$f ( {z}^{j} ) = {\sum }_{i = 1}^{m} c ( {z}_{i}^{j} ) + V ( {\prod }_{i = m + 1}^{m + p} c ( {z}_{i}^{j} ) ) \qquad Eq . ( 8 )$$

for V. The last p terms of z are the output variable values computed from the n inputs.

2. Illustrative Implementations

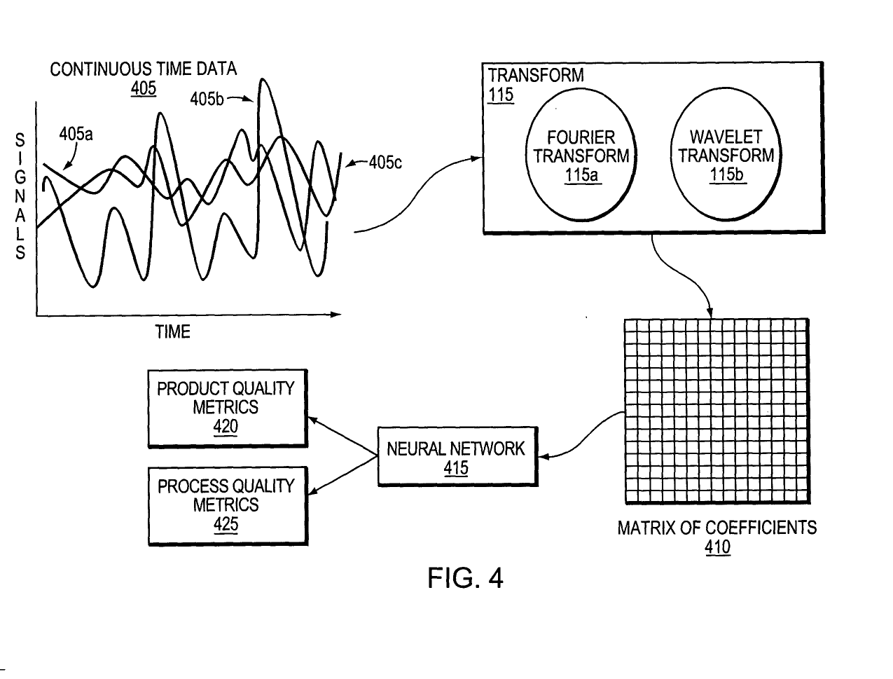

FIG. 4 schematically illustrates an embodiment of the invention in which continuous time data 405 representing one or more time-varying process signals 405a, 405b, and 405c (such as multi-channel optical emissions or in situ radio-frequency diagnostics in a semiconductor-fabrication process) is collected and processed using an orthogonal transform 115 such that the continuous-time data is decomposed into discrete measurement values, which in turn produce coefficients for a regression model that may be represented as a matrix 410. The matrix of coefficients 410, in turn, is mapped via a regression model (preferably a neural network 415) to product quality 420 and process quality 425 metrics (such as film thickness or etch rate). This procedure establishes implicit relationships between the original, time-varying process signals 405 (represented in discrete form by the transform coefficients) and the output parameters of interest. In the context of a trained neural network, this relationship is encoded in the weights, and the neural network may thereupon be used for prediction or failure analysis. For example, varying process parameters will produce changes in the process signals. These changes, which may be observed or computed, are fed through the neural network to determine the likely effect of the process variation on the output metric(s) of interest. Conversely, when confronted with unacceptable output metric values, a neural network can be used to identify the process signal (and, hence, the process) responsible for these.

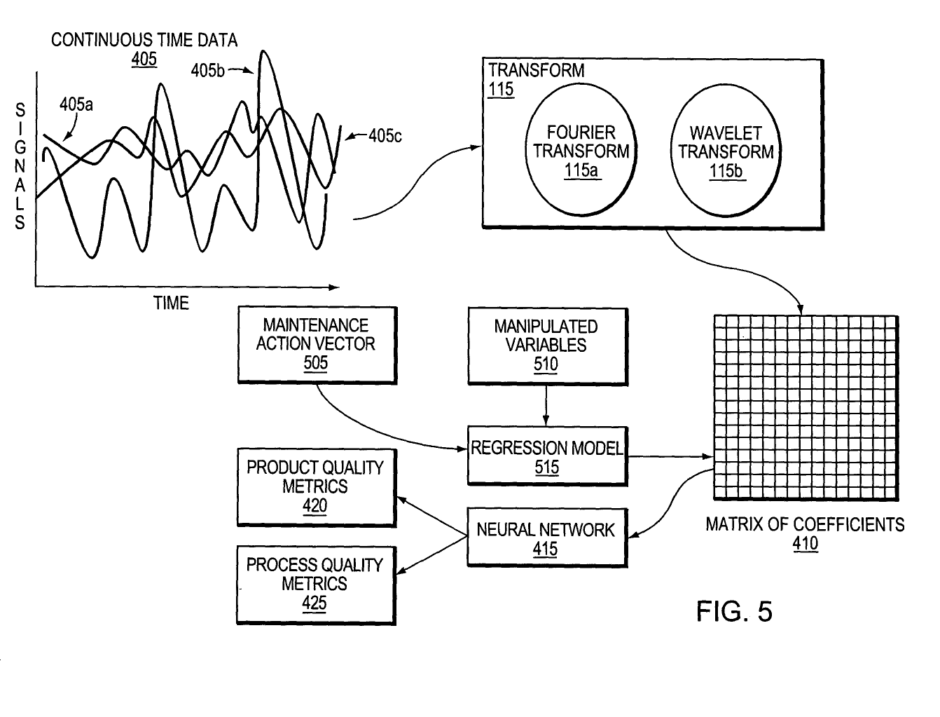

In a second embodiment, illustrated in FIG. 5, the regression analysis 515 maps one or more maintenance variables representing maintenance actions (such as recalibration, replacement, etc.) contained in a maintenance action vector 505 and manipulated variables 510 to the matrix of transform coefficients 410. In this way, maintenance variables 505 and manipulated variables 510 (which are manipulable and not represented by time-varying signals) are included in the mix of inputs used by the neural network 415 to predict outputs 420 and 425.

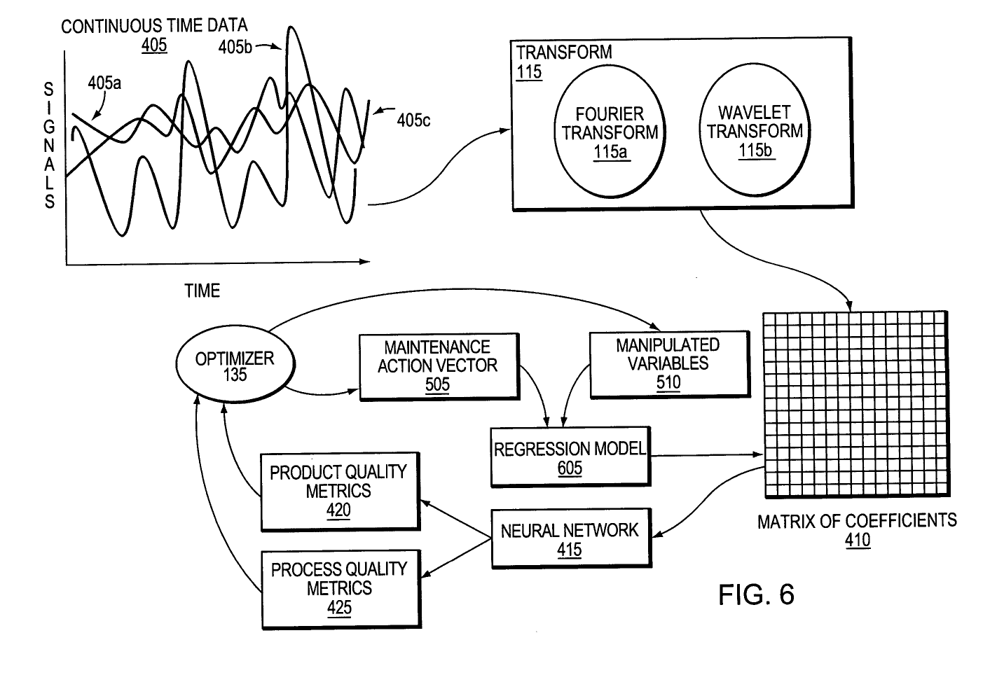

In a third embodiment, illustrated in FIG. 6, a regression model 605 is trained on the inverse mapping of one or more maintenance variables 505 and manipulated variables 510 to the transform coefficient matrix 410. In some embodiments, the regression model 605 is a neural network. The regression model 605 encodes the effects of maintenance actions and values of the manipulated variables on process performance as measured by the process signals. The transform coefficients 410, in turn, are fed into the neural network 415 to predict the product quality 420 and 425, which are then fed into an optimizer 135 to compute an ideal maintenance action vector 505 and manipulated variables 510.

The optimizer 135 determines target values of the maintenance action vector 505 and manipulated variables 510 to achieve one or more predicted matrix values while maintaining the lowest cost feasible. The cost of the predicted matrix values are determined by the cost of the predicted product and quality metrics using the neural network 415. The optimization procedure then optimizes the maintenance variables 505 and manipulated variables 510 against a cost function for the maintenance variables, manipulated variables and product and quality metrics.

In a fourth embodiment, the inputs to the regression model are the matrix of coefficients, maintenance actions, and/or real-time, in situ process signals. The regression model maps these inputs to post-process metrics. As in the third embodiment, an optimizer is utilized to constrain and optimize the maintenance variables.

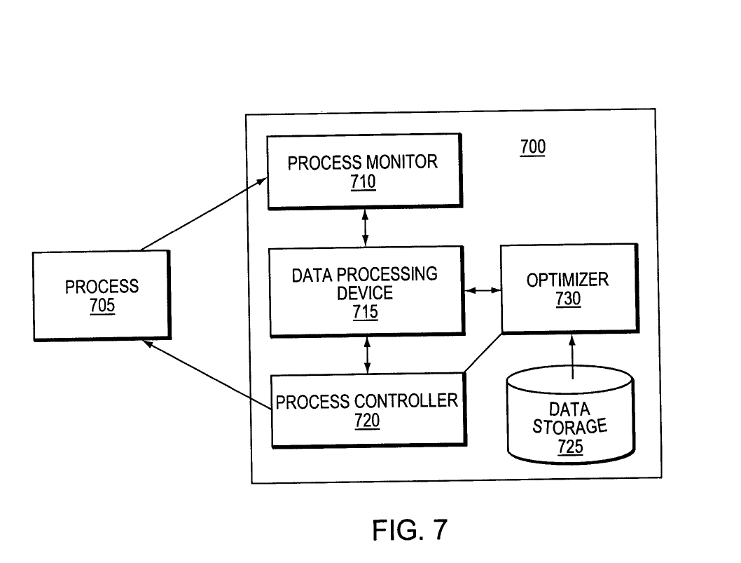

FIG. 7 schematically represents a hardware embodiment of the invention realized as a system 700 for predicting and optimizing a process 705 with respect to an associated process metric. The system 700 comprises a process monitor 710, a data processing device 715, a process controller 720, a data storage device 725, and an optimizer 730.

The process monitor 710 receives time-varying measurements relating to the process 705. The time-varying measurements may reflect one or more aspects of the operation of the process 705, such as tool pressure, etch rate, or power supply, and/or the environment in which the process is operating, such as temperature, or other operational measurements. The process monitor 710 generally includes conventional ports and may also include circuitry for receiving time-varying analog data signals, and analog-to-digital conversion circuitry for digitizing the signals.

The process monitor 710 causes the time-varying measurements to be transmitted to the data processing device 715. The data processing device 715, using methods described above, decomposes the time-varying measurements into discrete measurement values using an orthogonal transform such as, for example, a Fourier transform or a wavelet transform. In some embodiments, the data processing device 715 may implement the functionality of the present invention in hardware, using, for example, a computer chip implementing a Fast-Fourier Transform or other orthogonal transform. The data processing device 715 may receive signals in analog or digital form. In other embodiments, the data processing device 715 may implement the functionality of the present invention as software on a general purpose computer. In addition, such a program may set aside portions of a computer's random access memory to provide control logic that affects one or more of the measuring of metrics, the measuring of operational variables, the provision of target metric values, the provision of constraint sets, the prediction of metrics, the determination of metrics, the implementation of an optimizer, determination of operational variables, and detecting deviations of or in a metric. In such an embodiment, the program may be written in any one of a number of high-level languages, such as FORTRAN, PASCAL, C, C++, Tcl, or BASIC. Further, the program can be written in a script, macro, or functionality embedded in commercially available software, such as EXCEL or VISUAL BASIC. Additionally, the software could be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

The optimizer 730, using at least one set of acceptable ranges for the discrete measurement values provided by the data storage device 725, determines, based on the decomposed discrete measurement values and the range of acceptable process metrics (input), measurement values that produce a predicted (output) process metric for the process 705 that is substantially close to a target process metric. The optimizer 730 then causes the measurement values to be transmitted to the data processing device 715.

The data processing device 715, having received the measurement values from the optimizer 730 and having decomposed the time-varying measurements into discrete measurement values, builds a model that maps the relationship between the discrete measurement values and the associated process metric. The data processing device 715 then instructs the process controller 720 to change one or more operational aspects of the process 705 in such a manner as to bring the associated process metric within an acceptable range of a target process metric. The process controller 720 may be, for example, a conventional programmable logic controller (PLC) or a group of PLCs that control one or more manipulable variables of the process, e.g., by governing valves, ports, machine controls, thermostats, etc. In some embodiments, the optimizer 730 communicates directly with the process controller 720, sending instructions for manipulating the process 705.

While the invention has been particularly shown and described with reference to specific embodiments, it should be understood by those skilled in the area that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of prediction of a process having an associated process metric, the method comprising the steps of:
(a) obtaining time-varying measurements of parameters relating to the process;
(b) decomposing the time-varying measurements into discrete measurement values using an orthogonal transform; and
(c) modeling a relationship between the discrete measurement values and the associated process metric to determine a predicted process metric value from an input set of discrete measurement values.

2. The method of claim I wherein the modeling step comprises building a nonlinear regression model of the relationship between the discrete measurement values and the associated process metric to determine the predicted process metric value.

3. The method of claim 1 wherein the orthogonal transform is a Fourier transform.

4. The method of claim 1 wherein the orthogonal transform is a wavelet transform.

5. The method of claim 1 further comprising the steps of:
(d) providing at least one range of acceptable discrete measurement values to define a constraint set;
(e) identifying a plurality of input process variable values that produce discrete measurement values within the constraint set; and
(f) using the modeled relationship in conjunction with an optimizer to determine the discrete measurement values, produced by the input process variable values, that produce a predicted process metric value substantially as close as possible to a target process metric value.

6. The method of claim 5, further comprising the step of repeating steps (a)-(e) for at least one sub-process of the process.

7. The method of claim 5, further comprising the step of repeating steps (a)-(e) for a higher-level process comprising a plurality of the processes.

8. The method of claim 1 wherein the input set of discrete measurement values is obtained by decomposing time-varying measurements into discrete measurement values using an orthogonal transform.

9. An article of manufacture having a computer-readable medium with computer-readable instructions embodied thereon for performing the method of claim 1.

10. A method of prediction and optimization of maintenance actions for a process, the method comprising the steps of:
(a) obtaining time-varying measurements of parameters relating to the process;
(b) decomposing the time-varying measurements into discrete measurement values using an orthogonal transform; and
(c) modeling a relationship between at least one maintenance variable and the discrete measurement values to determine predicted measurement values from an input set of maintenance variable values.

11. The method of claim 10 wherein the modeling step comprises building a nonlinear regression model of the relationship between at least one maintenance variable and the discrete measurement values to determine the predicted measurement values.

12. The method of claim 11 wherein the nonlinear regression model maps a relationship between (i) a plurality of maintenance variables and associated process inputs, and (ii) discrete measurement values, the nonlinear regression model being used to determine a predicted measurement value from an instance of the input set of maintenance-variable values.

13. The method of claim 12 wherein the orthogonal transform is a Fourier transform.

14. The method of claim 12 wherein the orthogonal transform is a wavelet transform.

15. The method of claim 12 further comprising the steps of:
(d) providing at least one range of acceptable values for at least one maintenance variable to define a constraint set; and
(e) using the modeled relationship in conjunction with an optimizer to determine values for the at least one maintenance variable within the constraint set that produce at least one predicted discrete measurement value substantially as close as possible to a target discrete measurement value.

16. The method of claim 15, wherein costs are associated with at least one of the maintenance values used by the optimizer.

17. The method of claim 10 further comprising modeling a relationship between (i) an input set comprising at least one maintenance variable and the discrete measurement values and (ii) the process inputs in order to determine a predicted process metric value from an instance of the input set.

18. An article of manufacture having a computer-readable medium with computer-readable instructions embodied thereon for performing the method of claim 10.

19. A system for predicting a process having an associated process metric, comprising:
(a) a process monitor for monitoring time-varying measurements relating to process metrics; and
(b) a data processing device for predicting the process by (i) decomposing the time-varying measurements into discrete measurement values using an orthogonal transform, and (ii) modeling a relationship between the discrete measurement values and the associated process metric to determine a predicted process metric from an input set of discrete measurement values.

20. The system of claim 19 further comprising a process controller, responsive to the data processing device, for adjusting at least one of the processes based on the predicted process metric.

21. The system of claim 19 further comprising a data storage device for providing at least one range of acceptable discrete measurement values.

22. The system of claim 21 further comprising an optimizer for determining values for the process inputs that (i) produce predicted discrete measurement values substantially as close a possible to a target value provided by the data storage device.

23. The system of claim 22 wherein the optimizer is a feature of the data processing device.

24. A system for predicting and optimizing maintenance actions for a process, comprising:
(a) a process monitor for monitoring time-varying measurements of parameters relating to the process; and
(b) a data processing device for predicting the process by (i) decomposing the time-varying measurements into discrete measurement values using an orthogonal transform and (ii) modeling a relationship between at least one maintenance variable and the discrete measurement values to determine predicted measurement values from an input set of maintenance values.

25. The system of claim 24 further comprising a process controller, responsive to the data processing device, for adjusting at least one of the processes based on the predicted process metric.

26. The system of claim 24 further comprising a data storage device for providing at least one range of acceptable discrete measurement values.

27. The system of claim 26 further comprising an optimizer for determining measurement values that (i) produce a predicted process metric value substantially as close a possible to a target process metric, and (ii) are within the at least one range of acceptable values for the discrete measurement values provided by the data storage device.
